(19) United States
(12) Patent Application Publication
(10) Pub. No.: US 2016/0264087 A1
(43) Pub. Date: Sep. 15, 2016

(54) VEHICLE MOVEMENT CONTROL DEVICE, NON-TRANSITORY COMPUTER READABLE MEDIUM, AND VEHICLE

(71) Applicant: TOYOTA JIDOSHA KABUSHIKI KAISHA, Toyota-shi (JP)

(72) Inventor: Yukito OHMURA, Nagoya-shi (JP)

(73) Assignee: TOYOTA JIDOSHA KABUSHIKI KAISHA, Toyota-shi (JP)

(21) Appl. No.: 15/010,156

(22) Filed: Jan. 29, 2016

(30) Foreign Application Priority Data
Mar. 12, 2015 (JP) 2015-050032

(51) Int. Cl. B60R 21/0134; B60R 21/36

(52) U.S. Cl. CPC B60R 21/0134; B60R 21/36; B60R 2021/01293

(57) ABSTRACT

The present disclosure provides a vehicle movement control device including: a projection unit that causes a projecting member, that is capable of projecting to a lower side of a vehicle, to project to a position at which the projecting member touches a road surface; and a control unit that, in a case in which a collision of the vehicle is predicted by a prediction unit that predicts a collision of the vehicle, controls the projection unit such that the projecting member projects to the lower side of the vehicle and a predetermined vehicle attitude is adopted.

### CROSS-REFERENCE TO RELATED APPLICATION

This application claims priority under 35 USC 119 from Japanese Patent Application No. 2015-050032, filed on Mar. 12, 2015, the disclosure of which is incorporated by reference herein.

### BACKGROUND

1. Technical Field

The present disclosure relates to a vehicle movement control device, a non-transitory computer readable medium storing a vehicle movement control program and vehicle that suppress a vehicle movement such as pitching or the like in a case of a collision.

2. Related Art

Japanese Patent Application Laid-Open (JP-A) No. 2008-37246 proposes equipping a pedestrian protection airbag device below a vehicle at a front bumper of the vehicle. In a case in which the vehicle collides with a pedestrian, the pedestrian protection airbag device expands diagonally forward and downward of the vehicle, thus preventing entanglement of the legs of the pedestrian.

However, in JP-A No. 2008-37246, although entanglement of the legs of a pedestrian may be prevented, the airbag device expands after the collision has occurred. Therefore, a vehicle movement such as pitching of the vehicle or the like during the collision may not be suppressed by the airbag device. If a collision occurs in a state in which a vehicle movement such as pitching or the like is occurring, an under-ride collision, an over-ride collision or the like may occur. In an under-ride collision, the vehicle passes beneath another vehicle involved in the collision. In an over-ride collision, the vehicle rides over the other party in the collision. Accordingly, there is scope for improvement in regard to suppressing vehicle movements during collisions.

### SUMMARY

The present discloser provides a vehicle movement control device, a non-transitory computer readable medium storing a vehicle movement control program and a vehicle that may suppress a vehicle movement before a collision.

A vehicle movement control device according to the first aspect includes: a projection unit that causes a projecting member, that is capable of projecting to a lower side of a vehicle, to project to a position at which the projecting member touches a road surface; and a control unit that, in a case in which a collision of the vehicle is predicted by a prediction unit that predicts a collision of the vehicle, controls the projection unit such that the projecting member projects to the lower side of the vehicle and a predetermined vehicle attitude is adopted.

According to the first aspect, the projection unit projects the projecting member that can be projected to the lower side of the vehicle to the position that touches the road surface.

According to a second aspect, in the vehicle movement control device according to the first aspect, the projection unit may be provided at at least one of a front side or a rear side of the vehicle.

According to a third aspect, in the vehicle movement control device according to the above aspects, the projecting member may be a bag body of an airbag device that is capable of expanding to the lower side of the vehicle and suppressing a movement of the vehicle, or a moving member that is capable of moving to the vehicle lower side and suppressing a movement of the vehicle.

In a case in which a collision of the vehicle is predicted by the prediction unit that predicts a collision of the vehicle, the control unit controls the projection unit such that the projecting member is projected to the lower side of the vehicle and puts the vehicle into the predetermined vehicle attitude. That is, because the projecting member is projected to the lower side of the vehicle, a vehicle attitude that suppresses a movement such as pitching of the vehicle during braking or the like may be adopted. Moreover, because the vehicle may be put into the predetermined vehicle attitude that suppresses a movement of the vehicle before the collision, an over-ride collision, an under-ride collision or the like may be prevented.

According to a fourth aspect, in the vehicle movement control device according to the third aspect, the projecting member may be a moving member that moves between a projecting position at which the moving member is projected to the vehicle lower side and a stowed position at which the moving member is moved to a vehicle upper side, and that may be capable of suppressing a movement of the vehicle; and in a case in which avoidance of the collision of the vehicle is predicted by the prediction unit, the control unit may control the projection unit so as to move the moving member to the stowed position, after, in a case in which a collision of the vehicle is predicted by the prediction unit, the control unit moves the moving member to the projecting position and the predetermined vehicle attitude is adopted.

According to a fifth aspect, in the vehicle movement control device according to the above aspects, the projection unit may be provided at a framework member of the vehicle or a support member that is supported at the framework member.

Because the projection unit is provided at the framework member or the support member that is supported at the framework member, a movement such as pitching during braking or the like may be suppressed without the vehicle being deformed.

According to a sixth aspect, the vehicle movement control device according to the above aspects may further include a driving control unit that creates a running plan along a pre-specified target route on the basis of environment information of the vehicle and map information, and that controls driving such that the vehicle runs autonomously in accordance with the created running plan.

According to a seventh aspect, in the vehicle movement control device according to the sixth aspect, in a case in which a collision of the vehicle is predicted by the prediction unit during control by the driving control unit, the control unit may control the projection unit such that the projecting member is projected to the lower side of the vehicle and the predetermined vehicle attitude is adopted.

Thus, a vehicle movement before a collision may be suppressed even during automated driving.

An eighth aspect is a non-transitory computer readable medium storing a vehicle movement control program executable to cause a computer to function as the control unit of the vehicle movement control device according to the first aspect.

A ninth aspect is a vehicle including: a driving control unit that creates a running plan along a pre-specified target route on the basis of environment information of the vehicle and map information, and that controls driving such that the vehicle runs autonomously in accordance with the created running plan; and the vehicle movement control device according to the first aspect.

According to the aspects as described above, a vehicle movement before a collision may be suppressed.

### BRIEF DESCRIPTION OF THE DRAWINGS

Exemplary embodiments will be described in detail based on the following figures, wherein:

FIG. 1 is a view showing an airbag device that serves as an example of a control object of a vehicle movement control device according to a present exemplary embodiment;

FIG. 2 is a view showing a state in which the airbag device that serves as the example of the control object of the vehicle movement control device according to the present exemplary embodiment has expanded;

FIG. 3 is a block diagram showing a configuration of the vehicle movement control device according to the present exemplary embodiment;

FIG. 4 is a flowchart showing a flow of processing that is executed by a vehicle movement control ECU of the vehicle movement control device according to the present exemplary embodiment;

FIG. 5 is a view showing an alternative example of the control object of the vehicle movement control device; and

FIG. 6 is a flowchart showing a flow of processing that is executed by the vehicle movement control ECU of the vehicle movement control device according to the alternative example.

### DETAILED DESCRIPTION

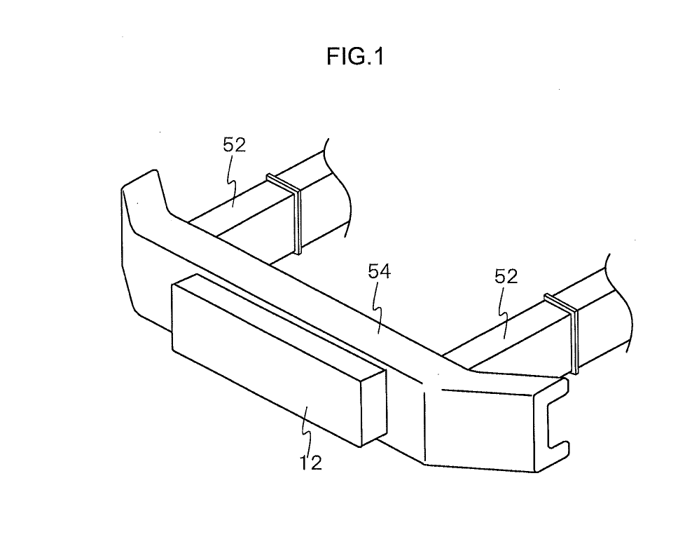

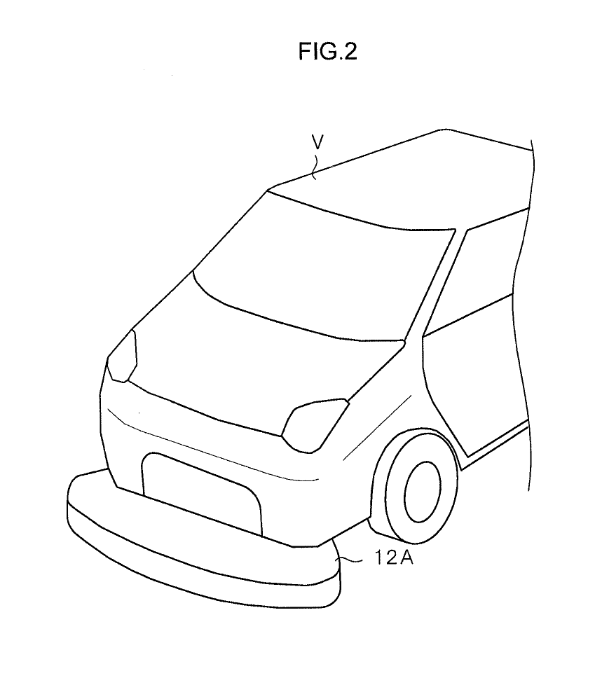

Herebelow, an example of an exemplary embodiment of the present disclosure is described in detail with reference to the attached drawings. FIG. 1 is a view showing an airbag device that serves as an example of a control object of a vehicle movement control device according to the present exemplary embodiment. FIG. 2 is a view showing a state in which the airbag device that serves as the example of the control object of the vehicle movement control device according to the present exemplary embodiment has expanded.

The vehicle movement control device according to the present exemplary embodiment is provided in a vehicle V and controls expansion of an airbag device 12 that serves as a projection unit, which is the example of the control object.

The airbag device 12 is equipped at a bumper reinforcement 54 that serves as an example of a support member, which is supported at a pair of left and right front side members 52 that serve as a framework member. The bumper reinforcement 54 is, for example, formed of metal in a long, narrow shape, and is disposed with a length direction thereof oriented to match the vehicle width direction. The airbag device 12 may be disposed at the front side members 52 rather than at the bumper reinforcement 54.

Vicinities of both the length direction ends of the bumper reinforcement 54 are inflected towards the rear of the vehicle. Thus, the bumper reinforcement 54 is formed in a shape that matches the external shape of the vehicle V. Depending on the external shape of the vehicle V, the bumper reinforcement 54 may be curved overall or may be formed in a linear shape that is not inflected or curved.

At the airbag device 12, gas is generated by an inflator (not shown in the drawings), a bag body 12A that serves as a projecting member is expanded by the generated gas, and the bag body 12A projected in the lower side direction of the vehicle V as far as a position at which the bag body 12A touches a road surface. Thus, due to the bag body 12A being expanded, the bag body 12A comes into contact with the road surface and controls the vehicle attitude. In the present exemplary embodiment, in a case in which a collision is determined to be unavoidable, the bag body 12A of the airbag device 12 is expanded to below the vehicle V. Thus, the vehicle V is put into a predetermined vehicle attitude that suppresses a movement such as pitching of the vehicle or the like. Because the predetermined vehicle attitude that suppresses a movement of the vehicle is adopted before the collision, an under-ride collision, in which the vehicle passes beneath another vehicle involved in the collision, an over-ride collision, in which the vehicle rides over the other party in the collision, or the like may be prevented.

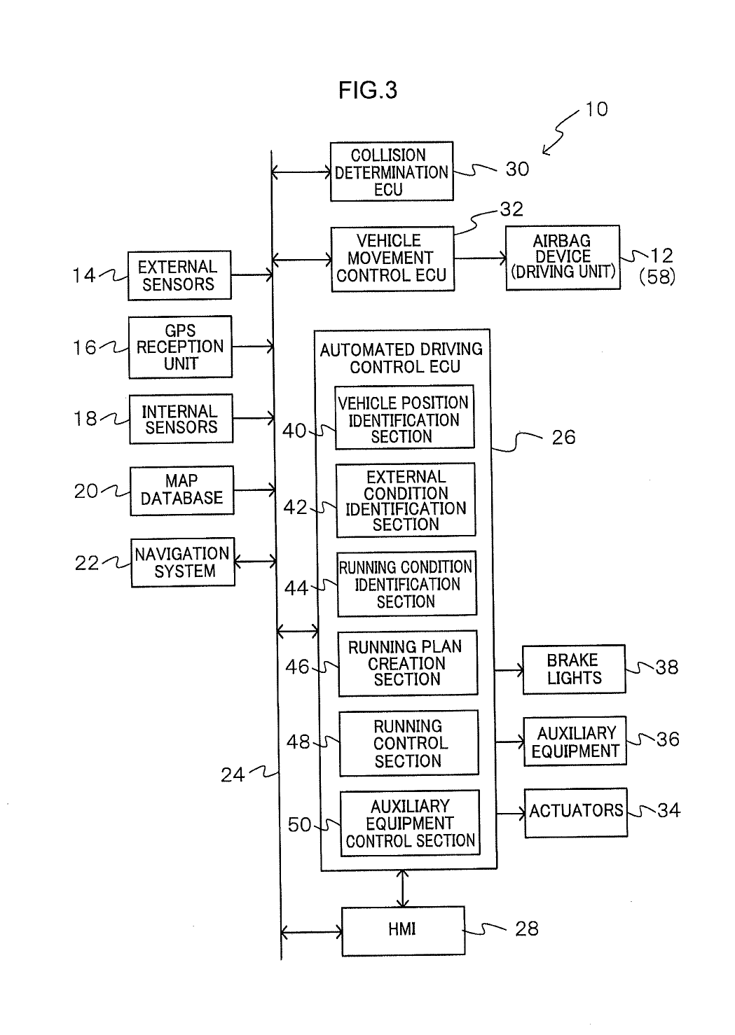

Now, the configuration of the vehicle movement control device according to the present exemplary embodiment is described. FIG. 3 is a block diagram showing the configuration of the vehicle movement control device according to the present exemplary embodiment.

A vehicle movement control device 10 includes external sensors 14, a global positioning system (GPS) reception unit 16, internal sensors 18, a map database 20 and a navigation system 22, which are respectively connected to an on-board network 24 such as a controller area network (CAN) or the like. An automated driving control electronic control unit (ECU) 26 that serves as a driving control unit, a human machine interface (HMI) 28, a collision determination ECU 30 that serves us a prediction section, and a vehicle movement control ECU 32 that serves as a control unit are also respectively connected to the on-board network 24.

The external sensors 14 detect external conditions which are environment information of the vehicle V. The external sensors 14 include at least one of a camera, a radar and a lidar (laser imaging detection and radiation). For example, a camera is provided inside the cabin at an upper portion of the front glass of the vehicle V and acquires image information by imaging external conditions of the vehicle V. The camera is capable of sending acquired image information to equipment that is connected to the on-board network 24. The camera may be a single lens camera and may be a stereo camera. In the case of a stereo camera, the camera includes two imaging units disposed so as to reproduce binocular parallax. Depth direction information is included in the image information from a stereo camera. A radar transmits electromagnetic waves (for example, millimeter waves) to the surroundings of the vehicle V, detects obstacles by receiving electromagnetic waves reflected by the obstacles, and is capable of sending detected obstruction information to equipment that is connected to the on-board network 24. A lidar transmits light to the surroundings of the vehicle V, measures distances to reflection points by receiving light reflected by obstacles, and thus detects the obstacles. The lidar is capable of sending detected obstacle information to equipment that is connected to the on-board network 24. A camera, a lidar and a radar are not necessarily equipped in combination.

The GPS reception unit 16 measures the position of the vehicle V (for example, the latitude and longitude of the vehicle V) by receiving signals from three or more GPS satellites. The GPS reception unit 16 is capable of sending position information of the vehicle V whose position has been measured to equipment that is connected to the on-board network 24. Alternative means capable of determining the latitude and longitude of the vehicle V may be employed instead of the GPS reception unit 16. In order to check measurement results of the sensors against map information, which is described below, it is also preferable to provide a function that measures the orientation of the vehicle V.

The internal sensors 18 detect vehicle conditions such as running states and the like by detecting physical quantities during running of the vehicle V. The internal sensors 18 include at least one of, for example, a vehicle speed sensor, an acceleration sensor and a yaw rate sensor. For example, a vehicle speed sensor is provided at a wheel of the vehicle V, a hub that turns integrally with the wheel, a rotor, a driveshaft or the like, and detects a vehicle speed by detecting a rotation speed of the wheel(s). The vehicle speed sensor is capable of sending detected vehicle speed information (wheel speed information) to equipment that is connected to the on-board network 24. An acceleration sensor detects accelerations produced by speeding and slowing of the vehicle V, turning, collisions and the like. The acceleration sensor includes, for example, a front-and-rear acceleration sensor that detects accelerations of the vehicle V in the front-and-rear direction and a lateral acceleration sensor that detects lateral accelerations of the vehicle V. The acceleration sensor is capable of sending acceleration information of the vehicle V to equipment that is connected to the on-board network 24. A yaw rate sensor detects a yaw rate (turning angular velocity) about a vertical axis at the center of gravity of the vehicle V. For example, a gyro sensor may be employed as the yaw rate sensor. The yaw rate sensor is capable of sending detected yaw rate information to equipment that is connected to the on-board network 24.

The map database 20 is a database provided with map information. The map database 20 is for example, memorized in a hard disk drive mounted in the vehicle V. The map information includes, for example, position information of roads, information on road conditions (for example curves, types of linear sections, curvature of curves and the like), and position information of intersections and junctions. Further, for the use of position information of shading structures such as buildings, walls and the like, and simultaneous localization and mapping (SLAM) technology, output signals of the external sensors 14 may be included in the map information. The map database 20 may be memorized in a computer at a facility such as an information processing center or the like that is capable of communicating with the vehicle V.

The navigation system 22 guides a driver of the vehicle V to a destination specified by the driver of the vehicle V. The navigation system 22 calculates a route for the vehicle V to run along on the basis of position information of the vehicle V measured by the GPS reception unit 16 and the map information of the map database 20. For sections with multiple driving lanes, the route may specify preferred lanes. For example, the navigation system 22 computes a target route to the destination from the position of the vehicle V, and informs occupants of the target route by displays at a display and voice outputs from a speaker. The navigation system 22 is capable of sending information of the target route of the vehicle V to equipment that is connected to the on-board network 24. Functions of the navigation system 22 may be stored in a computer at a facility such as an information processing center or the like that is capable of communicating with the vehicle V.

The automated driving control ECU 26 is constituted by a microcomputer including a central processing unit (CPU), a read-only memory (ROM), a random access memory (RAM) and the like. Actuators 34, auxiliary equipment 36, brake lights 38 and the HMI 28 are connected to the automated driving control ECU 26.

The automated driving control ECU 26 loads a program memorized in advance in the ROM into the RAM and executes the program at the CPU. Thus, the automated driving control ECU 26 controls automated driving by controlling operations of the actuators 34, the auxiliary equipment 36, the brake lights 38, the HMI 28 and the like. The automated driving control ECU 26 may be constituted by plural electronic control units.

The actuators 34 are control objects during automated driving control of the vehicle V. The automated driving control ECU 26 implements running control of the vehicle V by controlling operations of the actuators 34. To be specific, the actuators 34 include at least a throttle actuator, a brake actuator and a steering actuator. The throttle actuator controls a supply amount of air to the engine (a throttle opening) according to commands from the automated driving control ECU 26 and thus controls driving power of the vehicle V. If the vehicle V is a hybrid vehicle or an electric car, the throttle actuator is not included but commands from the automated driving control ECU 26 are inputted to a motor that serves as a power source to control driving power. The brake actuator controls a braking system according to commands from the automated driving control ECU 26. The brake actuator controls braking force applied to the wheels of the vehicle V and controls lighting of the brake lights 38. As an example, a hydraulic braking system may be employed as the braking system. According to commands from the automated driving control ECU 26, the steering actuator controls driving of an assistance motor that controls steering torque in an electric power steering system. Thus, the steering actuator controls steering torque of the vehicle V. The auxiliary equipment 36 is equipment that may be operated by a driver of the vehicle V at usual times. The auxiliary equipment 36 is a general term for equipment that is not included in the actuators 34. The auxiliary equipment 36 referred to herein includes, for example, indicator lights, headlamps, windshield wipers and the like.

More specifically, the automated driving control ECU 26 includes a vehicle position identification section 40, an external condition identification section 42, a running condition identification section 44, a running plan creation section 46, a running control section 48 and an auxiliary equipment control section 50. The automated driving control ECU 26 creates a running plan along a pre-specified target route on the basis of environment information of the vehicle according to the above-mentioned components and the map information, and controls driving such that the vehicle runs autonomously according to the created running plan.

The vehicle position identification section 40 identifies the position of the vehicle V on a map (herebelow referred to as “the vehicle position”) on the basis of position information of the vehicle V received by the GPS reception unit 16 and the map database 20. The vehicle position identification section 40 may acquire the vehicle position employed at the navigation system 22 from the navigation system 22 to identify the vehicle position. If the vehicle position can be measured by a sensor disposed outside the vehicle on a road or the like, the vehicle position identification section 40 may acquire the vehicle position by receiving signals from this sensor.

The external condition identification section 42 identifies external conditions of the vehicle V on the basis of detection results from the external sensors 14 (for example, image information from a camera, obstacle information from a radar, obstacle information from a lidar or the like). The external conditions include, for example, the positions of white lines of a driving lane relative to the vehicle V, the position of the lane center, the road width, the road topology, conditions of obstacles around the vehicle V, and so forth. The road topology may include, for example, curvature of the driving lane, estimated gradient changes and undulations of the available road surface forecast by the external sensors 14, and the like. Conditions of obstacles around the vehicle V may include, for example, information distinguishing fixed obstacles from moving obstacles, positions of the obstacles relative to the vehicle V, movement directions of the obstacles relative to the vehicle V, relative speeds of the obstacles relative to the vehicle V, and so forth. Checking detection results of the external sensors 14 against the map information is preferred for supplementing the accuracy of the position and direction of the vehicle V acquired by the GPS reception unit 16 or the like.

The running condition identification section 44 identifies running conditions of the vehicle V on the basis of detection results from the internal sensors 18 (for example, vehicle speed information from a vehicle sensor, acceleration information from an acceleration sensor, yaw rate information from a yaw rate sensor and the like). The running conditions of the vehicle V include, for example, the vehicle speed, acceleration and yaw rate.

The running plan creation section 46 creates a course for the vehicle V on the basis of, for example, the target route computed by the navigation system 22, the vehicle position identified by the vehicle position identification section 40, and the external conditions of the vehicle V identified by the external condition identification section 42 (including the vehicle position and orientation). The running plan creation section 46 creates a path along which the vehicle V will proceed along the target route to be the created course. The running plan creation section 46 creates the course such that the vehicle V runs along the target route excellently in consideration of standards such as safety, compliance with laws, running efficiency and so forth. Note that the running plan creation section 46 may create this course for the vehicle V on the basis of the conditions of obstacles around the vehicle V so as to avoid contact with the obstacles. Further, note that the meaning of the above term “target route” includes a running route that is automatically created so as to run along roads on the basis of external conditions, map information and the like when a destination is not explicitly specified by a driver, as in, for example, Japanese Patent No. 5,382,218 (WO2011/158347) and JP-A No. 2011-162132. The running plan creation section 46 creates a running plan according to the created course. Namely, the running plan creation section 46 creates a running plan along the pre-specified target route at least on the basis of external conditions, which are environment information of the vehicle V, and the map information in the map database 20. It is preferable if the running plan creation section 46 outputs the created running plan as a series in which the course of the vehicle V is constituted by pairs of elements (coordinate positions p in a coordinate system that is fixed for the vehicle V and velocities v at respective coordinate points) that is, as a plan containing plural configuration coordinates (p, v). Herein, the respective coordinate positions p include at least x-coordinate and y-coordinate positions in the coordinate system fixed for the vehicle V, or equivalent information. Note that the running plan is not particularly limited unless it represents movements of the vehicle V. The running plan may employ, for example, coordinate times t instead of velocities v, and may append orientations of the vehicle V at those times to the coordinate times t. Ordinarily, it is sufficient for a running plan to mainly be data for the next few seconds from the current moment. However, depending on situations, such as turning right at an intersection, overtaking of the vehicle V and the like, data for tens of seconds will be required. Therefore, it is preferable if a number of configuration coordinates in the running plan is variable and if distances between the configuration coordinates are variable. Further, a running plan may be formed of curve parameters in which curves joining the configuration coordinates are approximated by spline functions or the like. For the creation of a running plan, an arbitrary publicly known method may be employed, provided movements of the vehicle V can be represented. Further yet, a running plan may be data that represents changes in vehicle speed, acceleration/deceleration, steering torque of the vehicle V and the like when the vehicle V is running along the course along the target route. The running plan may include speed patterns, acceleration/deceleration patterns and steering patterns of the vehicle V. This running plan creation section 46 may create running plans such that a journey time (the required time needed for the vehicle V to reach the destination) is minimized. Incidentally, the term “speed pattern” refers to, for example, data constituted of coordinate vehicle speeds specified by associating coordinate control positions specified at a predetermined interval along the course (for example, 1 m) with durations for the respective coordinate control positions. The term “acceleration/deceleration pattern” refers to, for example, data constituted of coordinate accelerations that are specified by associating the durations for the respective coordinate control positions with the coordinate control positions specified at the predetermined interval along the course (for example, 1 m). The term “steering pattern” refers to, for example, data constituted of coordinate steering torques that are specified by associating the durations for the respective coordinate control positions with the coordinate control positions specified at the predetermined interval along the course (for example, 1 m).

The running control section 48 automatically controls running of the vehicle V on the basis of the running plan created at the running plan creation section 46. The running control section 48 outputs control signals to the actuators 34 according to the running plan. Thus, the running control section 48 controls driving of the vehicle V such that the vehicle V runs autonomously through the running plan. For autonomous running, when the running control section 48 is controlling the running of the vehicle V, the running control section 48 controls the running of the vehicle according to the running plan while monitoring identification results from the vehicle position identification section 40, the external condition identification section 42 and the running condition identification section 44.

The auxiliary equipment control section 50 combines signals outputted from the HMI 28 with the running plan created at the running plan creation section 46 and controls the auxiliary equipment 36.

The collision determination ECU 30 is constituted by a microcomputer including a CPU, a ROM, a RAM and the like. The collision determination ECU 30 loads a program memorized in advance in the ROM into the RAM and executes the program at the CPU. Thus, on the basis of respective detection results from the external sensors 14 and the internal sensors 18, the collision determination ECU 30 predicts a collision of the vehicle V and determines in a case there is a collision. For example, the collision determination ECU 30 calculates relative distances and relative speeds to obstacles from the external conditions detected by the external sensors 14, and predicts a collision on the basis of the calculated relative distances and relative speeds, running states of the vehicle V detected by the internal sensors 18, and so forth. Various widely known technologies may be employed for collision prediction of the vehicle. Further, the collision determination ECU 30 determines in a case there is a collision from, for example, running states of the vehicle V detected by the internal sensors 18 (for example, accelerations, changes in vehicle speed and the like).

The vehicle movement control ECU 32 is constituted by a microcomputer including a CPU, a ROM, a RAM and the like. The vehicle movement control ECU 32 loads a program memorized in advance in the ROM into the RAM and executes the program at the CPU. Thus, on the basis of the collision prediction at the collision determination ECU 30, the vehicle movement control ECU 32 controls expansion of the airbag device 12 and controls movements of the vehicle V before the collision. For example, if a collision is predicted by the collision determination ECU 30 and the collision is determined to be unavoidable, the vehicle movement control ECU 32 expands the bag body 12A of the airbag device 12 before the collision of the vehicle V. Due to the bag body 12A of the airbag device 12 being expanded in the lower side direction of the vehicle V, a predetermined vehicle attitude is adopted in which a movement such as pitching of the vehicle V or the like is suppressed by the bag body 12A of the airbag device 12. Because a movement of the vehicle V before the collision is suppressed, an under-ride collision, an over-ride collision or the like may be prevented.

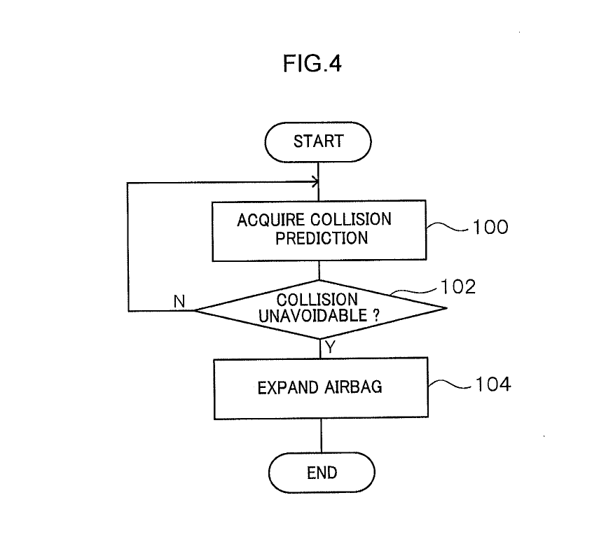

Now, specific processing that is executed by the vehicle movement control ECU 32 of the vehicle movement control device 10 according to the present exemplary embodiment is described. FIG. 4 is a flowchart showing the flow of processing that is executed by the vehicle movement control ECU 32 of the vehicle movement control device 10 according to the present exemplary embodiment. The processing in FIG. 4 is described as starting in a case in which an ignition switch (not shown in the drawings) is turned ON. However, the present exemplary embodiment is not limited thereto. For example, the processing may start in a case in which automated driving by the automated driving control ECU 26 is started or, in a case in which manual driving is started when an execution setting for vehicle movement control is set by operation of a switch or the like by an occupant.

In step 100, the vehicle movement control ECU 32 acquires a collision prediction from the collision determination ECU 30 via the on-board network 24, and the vehicle movement control ECU 32 proceeds to step 102.

In step 102, the vehicle movement control ECU 32 makes a determination as to whether the acquired collision prediction is an unavoidable collision. If the result of this determination is affirmative, the vehicle movement control ECU 32 proceeds to step 104. On the other hand, in a case in which the result of the determination is negative, the vehicle movement control ECU 32 returns to step 100 and repeats the processing described above.

In step 104, the vehicle movement control ECU 32 outputs an expansion command to the airbag device 12, as a result of which the bag body 12A of the airbag device 12 expands to the lower side of the vehicle V, and this sequence of processing ends. In this expansion at the airbag device 12, the expansion of the bag body 12A is completed before braking is applied and a pitching angle that would cause an under-ride collision, an over-ride collision or the like is reached. Thus, as illustrated in FIG. 2, the bag body 12A of the airbag device 12 is expanded to the lower side of the vehicle V. As a result of the bag body 12A being expanded between the vehicle V and a road surface, pitching due to braking is controlled by the bag body 12A and a force toward the upper side of the vehicle V acts on the bumper reinforcement 54. Thus, the vehicle V is put into the predetermined vehicle attitude in which pitching of the vehicle V is suppressed. Because the airbag device 12 is equipped at the bumper reinforcement 54 that is supported at the front side members 52, the force from the bag body 12A acts on the front side members 52 without the airbag device 12 being released to the upper side. Therefore, pitching may be suppressed reliably. Because pitching of the vehicle V is suppressed in this manner, an under-ride collision, over-ride collision or the like with a vehicle in front may be prevented.

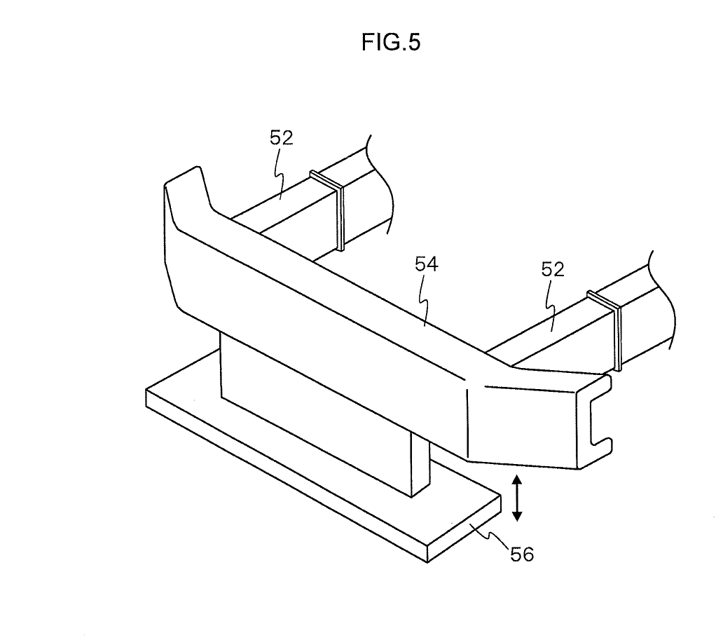

Now, a vehicle movement control device according to an alternative example is described. FIG. 5 is a view showing an alternative example of the control object of the vehicle movement control device.

In the exemplary embodiment described above, an example is described in which a vehicle movement is controlled by the bag body 12A of the airbag device 12 being expanded, but the method of controlling a vehicle movement is not limited thereto. Below, an alternative example of the vehicle movement control device 10 is described.

In the alternative example, a pitching movement suppression plate 56 that serves as a moving member is provided at the bumper reinforcement 54 that is supported at the pair of left and right front side members 52. The pitching movement suppression plate 56 may be equipped at the front side members 52 rather than at the bumper reinforcement 54.

The pitching movement suppression plate 56 is formed in a long, narrow shape in the vehicle width direction and is provided to be movable in the up-and-down direction of the vehicle V (the arrowed direction in FIG. 5). The pitching movement suppression plate 56 is driven by a driving unit 58 that serves as the projection unit (see FIG. 1). The pitching movement suppression plate 56 can be moved by driving by the driving unit 58, which is a hydraulic mechanism, a mechanical mechanism or the like, between a pitching suppression position, at which the pitching movement suppression plate 56 is projected in the lower side direction of the vehicle V to a position at which the pitching movement suppression plate 56 is in contact with a road surface, and a stowed position, at which the pitching movement suppression plate 56 has been moved to the side thereof at which the bumper reinforcement 54 is disposed. Namely, instead of the airbag device 12, the driving unit 58 that drives the pitching movement suppression plate 56 is connected to the vehicle movement control ECU 32 and movements of the vehicle V can be controlled by the vehicle movement control ECU 32 controlling the driving unit 58. In this alternative example, a plate-shaped member that is movable up and down as illustrated in FIG. 5 is employed as the pitching movement suppression plate. However, the present exemplary embodiment is not limited thereto. For example, a rod-shaped member that is movable up and down may be employed as the moving member. If a rod-shaped member is employed, it is preferable if the rod-shaped member is provided plurally along the vehicle width direction, such that the vehicle V does not turn about the rod-shaped member when the rod-shaped member contacts with the road surface and suppresses a movement of the vehicle V.

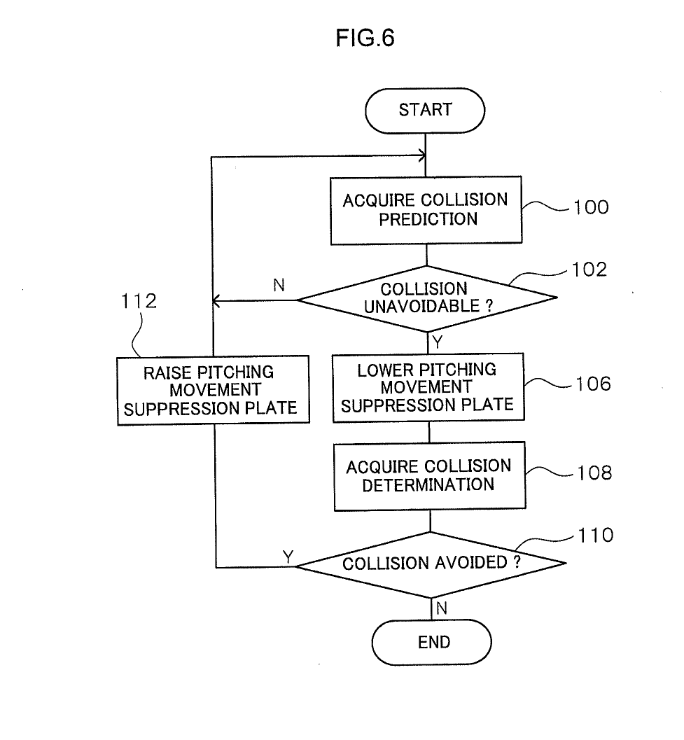

Now, specific processing that is executed by the vehicle movement control ECU 32 of the vehicle movement control device according to the alternative example is described. FIG. 6 is a flowchart showing the flow of processing that is executed by the vehicle movement control ECU 32 of the vehicle movement control device according to the alternative example. The processing in FIG. 6 is described as starting in a case in which the ignition switch (not shown in the drawings) is turned ON. However, the present exemplary embodiment is not limited thereto. For example, the processing may start in a case in which automated driving by the automated driving control ECU 26 is started or, in a case in which manual driving is started when the execution setting for vehicle movement control is set by operation of a switch or the like by an occupant. Processing that is the same as in the exemplary embodiment described above is assigned with the same reference number.

In step 100, the vehicle movement control ECU 32 acquires a collision prediction from the collision determination ECU 30 via the on-board network 24, and the vehicle movement control ECU 32 proceeds to step 102.

In step 102, the vehicle movement control ECU 32 makes a determination as to whether the acquired collision prediction is an unavoidable collision. In a case in which the result of this determination is affirmative, the vehicle movement control ECU 32 proceeds to step 106. However, in a case in which the result of the determination is negative, the vehicle movement control ECU 32 returns to step 100 and repeats the processing described above.

In step 106, the vehicle movement control ECU 32 drives the driving unit 58, causing the pitching movement suppression plate 56 to be projected to the lower side of the vehicle V by being lowered, and the vehicle movement control ECU 32 proceeds to step 108. This lowering of the pitching movement suppression plate 56 to the predetermined position is completed before braking is applied and a pitching angle that would cause an under-ride collision, an over-ride collision or the like is reached. Thus, because the pitching movement suppression plate 56 is provided at the bumper reinforcement 54 that is supported at the front side members 52, the vehicle V is put into the predetermined vehicle attitude in which pitching of the vehicle V is suppressed before the collision. Because pitching of the vehicle V is suppressed in this manner, an under-ride collision, over-ride collision or the like with a vehicle V in front may be prevented.

In step 108, the vehicle movement control ECU 32 acquires a collision determination from the collision determination ECU 30 via the on-board network 24, and the vehicle movement control ECU 32 proceeds to step 110.

In step 110, the vehicle movement control ECU 32 makes a determination as to whether the acquired collision determination is that the collision has been avoided. In a case in which the determination is affirmative, the vehicle movement control ECU 32 proceeds to step 112. However, in a case in which the result of the determination is negative, the processing ends.

In step 112, the vehicle movement control ECU 32 drives the driving unit 58, thus causing the pitching movement suppression plate 56 to be raised. The vehicle movement control ECU 32 then returns to step 100 and repeats the processing described above.

In the exemplary embodiment described above, since the movement of the vehicle V is controlled by the airbag device 12, the bag body 12A may expand in response to an erroneous collision prediction and cannot be re-used. In the alternative example, the projecting member may be re-used even in a case in which erroneous a collision prediction is m. Therefore, a standard for determining that a collision is unavoidable may be set more generously than in the exemplary embodiment described above, and a frequency with which movements of the vehicle V are suppressed may be made higher than in the above exemplary embodiment.

In the exemplary embodiment described above, an example is illustrated in which the airbag device 12 is provided at the front side of the vehicle V. However, the airbag device 12 may be provided at one or both of the front and rear of the vehicle V. Similarly, the pitching movement suppression plate 56 of the alternative example may be provided at one or both of the front and rear of the vehicle V. In a case in which the airbag device 12, the pitching movement suppression plate 56 or the like is provided at the rear of the vehicle V, then it is preferable to provide the projection unit at, for example, rear side members, a member that is supported at the rear side members, or the like. For example, the projection unit may be provided at suspension members that are supported at the rear side members.

In the exemplary embodiment described above, an example is described in which the automated driving control ECU 26, the collision determination ECU 30 and the vehicle movement control ECU 32 are structured by respective microcomputers. However, the present exemplary embodiment is not limited thereto. The functions of the respective ECUs may be implemented by a single microcomputer, or some functions may be included in alternative ECUs.

The processing that is executed by the vehicle movement control ECU 32 of the exemplary embodiment described above is described as being software processing that is implemented by a program being executed, but the processing may be implemented in hardware. Alternatively, the processing may combine both software and hardware. Further, the program memorized in the ROM may be memorized in any of various storage media and distributed.

The present disclosure is not limited by the above. In addition to the above, it will be clear that numerous modifications may be embodied within a technical scope not departing from the gist of the disclosure.

What is claimed is:

1. A vehicle movement control device comprising:
a projection unit that causes a projecting member, that is capable of projecting to a lower side of a vehicle, to project to a position at which the projecting member touches a road surface; and
a control unit that, in a case in which a collision of the vehicle is predicted by a prediction unit that predicts a collision of the vehicle, controls the projection unit such that the projecting member projects to the lower side of the vehicle and a predetermined vehicle attitude is adopted.

2. The vehicle movement control device according to claim 1, wherein the projection unit is provided at at least one of a front side or a rear side of the vehicle.

3. The vehicle movement control device according to claim 1, wherein the projecting member is:
a bag body of an airbag device that is capable of expanding to the lower side of the vehicle and suppressing a movement of the vehicle; or
a moving member that is capable of moving to the vehicle lower side and suppressing a movement of the vehicle.

4. The vehicle movement control device according to claim 3, wherein:
the projecting member is a moving member that moves between a projecting position at which the moving member is projected to the vehicle lower side and a stowed position at which the moving member is moved to a vehicle upper side, and that is capable of suppressing a movement of the vehicle; and
in a case in which avoidance of the collision of the vehicle is predicted by the prediction unit, the control unit controls the projection unit so as to move the moving member to the stowed position, after, in a case in which a collision of the vehicle is predicted by the prediction unit, the control unit moves the moving member to the projecting position and the predetermined vehicle attitude is adopted.

5. The vehicle movement control device according to claim 1, wherein the projection unit is provided at a framework member of the vehicle or a support member that is supported at the framework member.

6. The vehicle movement control device according to claim 1, further comprising a driving control unit that creates a running plan along a pre-specified target route on the basis of environment information of the vehicle and map information, and that controls driving such that the vehicle runs autonomously in accordance with the created running plan.

7. The vehicle movement control device according to claim 6, wherein, in a case in which a collision of the vehicle is predicted by the prediction unit during control by the driving control unit, the control unit controls the projection unit such that the projecting member is projected to the lower side of the vehicle and the predetermined vehicle attitude is adopted.

8. A non-transitory computer readable medium storing a vehicle movement control program executable to cause a computer to function as the control unit of the vehicle movement control device according to claim 1.

9. A vehicle comprising:
a driving control unit that creates a running plan along a pre-specified target route on the basis of environment information of the vehicle and map information, and that controls driving such that the vehicle runs autonomously in accordance with the created running plan; and
the vehicle movement control device according to claim 1.
